(19) United States
(12) Patent Application Publication
(10) Pub. No.: US 2011/0304644 A1
(43) Pub. Date: Dec. 15, 2011

(54) ELECTRONIC APPARATUS AND IMAGE DISPLAY METHOD

(75) Inventors: Kouetsu WADA, Nishitama-gun (JP); Kohei MOMOSAKI, Mitaka-shi (JP); Kenichi TABE, Ome-shi (JP); Tomonori SAKAGUCHI, Ome-shi (JP); Shunsuke TAKAYAMA, Tachikawa-shi (JP)

(73) Assignee: KABUSHIKI KAISHA TOSHIBA, Tokyo (JP)

(21) Appl. No.: 13/161,348

(22) Filed: Jun. 15, 2011

(30) Foreign Application Priority Data
Jun. 15, 2010 (JP) 2010-136536

(51) Int. Cl. G09G 5/00

(52) U.S. Cl. 345/619

(57) ABSTRACT

According to one embodiment, an electronic apparatus includes a face image detector and a display controller. The face image detector is configured to detect face images included in a still image and analyze the detected face images, and to generate face image information includes position information and attribute information. The position information indicates positions where the face images are detected. The attribute information indicates at least data items representing smile degrees of the face images. The display controller is configured to select a face image to be applied with effects based on the attribute information in the face image information, to apply effects to the still image based on the position information in the face image information of the selected face image, and to display the still image applied with the effects.

### CROSS-REFERENCE TO RELATED APPLICATIONS

This application is based upon and claims the benefit of priority from Japanese Patent Application No. 2010-136536, filed Jun. 15, 2010, the entire contents of which are incorporated herein by reference.

### FIELD

Embodiments described herein relate generally to an electronic apparatus which displays images and an image display method of the electronic apparatus.

### BACKGROUND

In recent years, the resolution of any imaging element such as a charge coupled device (CCD) or a complementary metal-oxide semiconductor (CMOS) image sensor has increased. Along with this technical trend, the resolution has been increased for still images processed by electronic apparatuses such as mobile telephones and personal computers.

Recently, image playback apparatuses called “digital photo frames” have come into use in increasing numbers. The digital photo frame includes the function of displaying still images stored in, for example, a card-shaped storage medium, one after another at prescribed intervals. Like the digital photo frame, most personal computers and most digital cameras include the function of displaying still images one after another at prescribed intervals. The way the digital photo frame displays still images is called, for example, “slide show display.”

Further, a moving-picture generating technique that enables the viewer to enjoy seeing still images (or only one still image) in a more enjoyable way is now attracting attention. This technique resides in adding various effects to still images and then editing the still images, thereby generating a moving picture. The moving picture thus generated is called a “photomovie,” for example. The above-mentioned slide show display can be performed not only by sequentially displaying still images at the prescribed intervals, but also by playing back a moving picture generated by the moving-picture generating technique. The moving picture (i.e., photomovie) generated for use in the slide show display is called a “slide show,” too.

In order to display a slide show composed of a plurality of still images, effects may be added to the faces contained in each still image. Usually, all faces are retrieved, and then prescribed effects are added to each retrieved face.

That is, if each still image contains the faces of persons, such methods as described below have not been used hitherto:

(i) Only one of the faces is selected from the still image, and effects for the selected face are applied to the still image.

(ii) Some of the faces are selected from the still images, and effects are applied to the still images containing the faces selected, thus applying more prominent effects thereto.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the outer appearance of an electronic apparatus according to an embodiment.

FIG. 2 is an exemplary diagram showing the system configuration of the electronic apparatus according to the embodiment.

FIG. 3 is an exemplary block diagram showing the function configuration of the photomovie creation application program executed by the electronic apparatus according to the embodiment.

FIG. 4 is an exemplary diagram showing exemplary index information used in the photomovie creation application program executed by the electronic apparatus according to the embodiment.

FIG. 5 is an exemplary diagram showing an example main menu screen that may be displayed by the electronic apparatus according to the embodiment.

FIG. 6 is an exemplary diagram showing an example main-character selection screen that may be displayed by the electronic apparatus according to the embodiment.

FIG. 7 is an exemplary diagram showing an example calendar screen that may be displayed by the electronic apparatus according to the embodiment.

FIG. 8 is an exemplary diagram outlining the sequence of photo-movie generating process executed by the electronic apparatus according to the embodiment.

FIG. 9 is an exemplary diagram showing a first example of effect that the electronic apparatus according to the embodiment may apply to the faces contained in a still image.

FIG. 10 is an exemplary diagram showing a second example of effect that the electronic apparatus according to the embodiment may apply to the faces contained in a still image.

FIG. 11 is an exemplary diagram showing a third example of effect that the electronic apparatus according to the embodiment may apply to the faces contained in a still image.

FIG. 12 is an exemplary diagram showing a first example of an image that has some effects applied by the electronic apparatus according to the embodiment.

FIG. 13 is an exemplary diagram showing a second example of an image that has some effects applied by the electronic apparatus according to the embodiment.

FIG. 14 is an exemplary diagram showing a third example of an image that has some effects applied by the electronic apparatus according to the embodiment.

FIG. 15 is an exemplary diagram showing a fourth example of an image that has some effects applied by the electronic apparatus according to the embodiment.

FIG. 16 is an exemplary diagram showing a fifth example of an image that has some effects applied by the electronic apparatus according to the embodiment.

FIG. 17 is an exemplary flowchart showing an example of a sequence of the indexing process that the electronic apparatus according to the embodiment executes.

FIG. 18 is an exemplary flowchart showing an example of sequence of the moving-picture generating process that the electronic apparatus according to the embodiment executes.

FIG. 19 is an exemplary flowchart showing an example of a sequence of the key-image selecting process that the electronic apparatus according to the embodiment executes.

FIG. 20 is an exemplary flowchart showing another example of a sequence of the key-image selecting process that the electronic apparatus according to the embodiment executes.

FIG. 21 is an exemplary flowchart showing an example of sequence of the related image selecting process that the electronic apparatus according to the embodiment executes.

### DETAILED DESCRIPTION

Various embodiments will be described hereinafter with reference to the accompanying drawings.

In general, according to one embodiment, an electronic apparatus includes a face image detector and a display controller. The face image detector is configured to detect face images included in a still image and analyze the detected face images, and to generate face image information comprising position information and attribute information. The position information indicates positions where the face images are detected. The attribute information indicates at least data items representing smile degrees of the face images. The display controller is configured to select a face image to be applied with effects based on the attribute information in the face image information, to apply effects to the still image based on the position information in the face image information of the selected face image, and to display the still image applied with the effects.

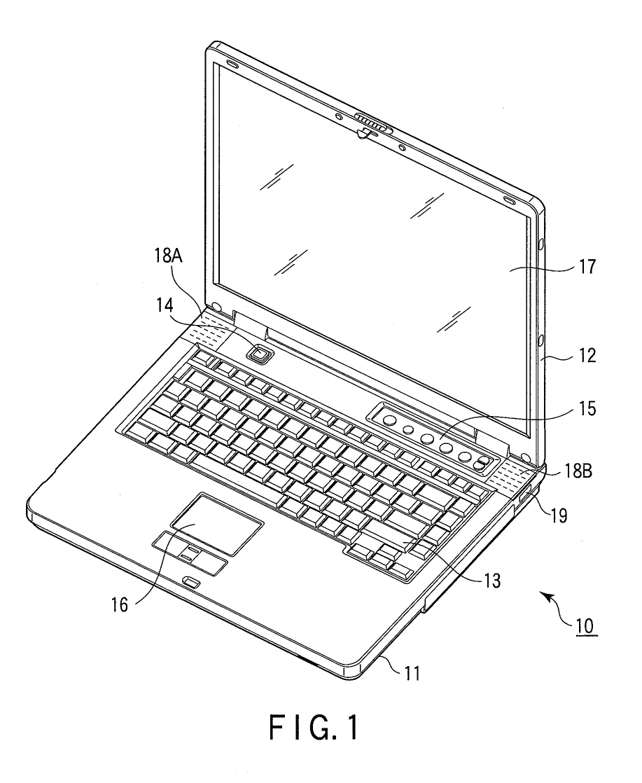

FIG. 1 is an exemplary perspective view showing the outer appearance of the electronic apparatus according to the embodiment. The electronic apparatus is a personal computer 10 of, for example, the notebook type. As shown in FIG. 1, the computer 10 includes a computer main unit 11 and a display unit 12. The display unit 12 incorporates a liquid crystal display (LCD) 17. The display unit 12 is secured to the computer main unit 11 and can rotate between an opened position and a closed position. In the opened position, the display unit 12 exposes the upper surface of the computer main unit 11. In the closed position, the display unit 12 covers the upper surface of the computer main unit 11.

The computer main unit 11 is shaped like a thin box. On its top, a keyboard 13, a power button 14, an input/output panel 15, a touch pad 16 and speakers 18A and 18B are arranged. The power button 14 may be operated to turn on or off the computer 10. The input/output panel 15 includes various buttons.

On the right side of the computer main unit 11, a USB connector 19 is provided, to which an USB cable or a USB device, both according with the universal serial bus (USB) 2.0 standards, can be connected.

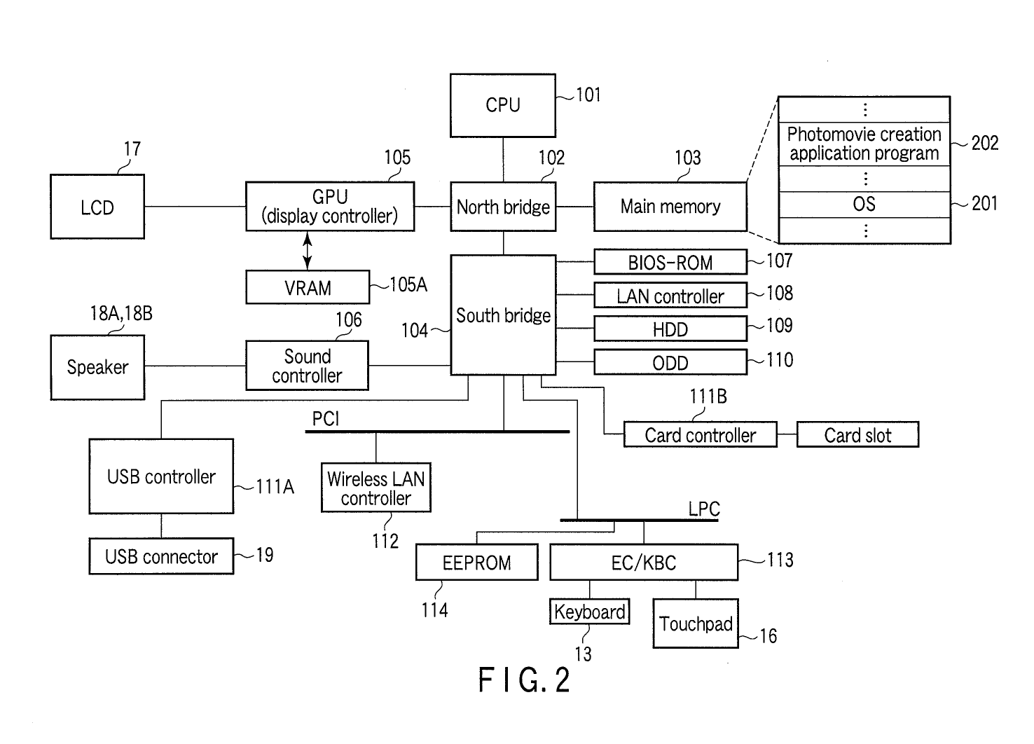

FIG. 2 is an exemplary diagram showing the system configuration of the electronic apparatus 10.

As shown in FIG. 2, the computer 10 includes a central processing unit (CPU) 101, a north bridge 102, a main memory 103, a south bridge 104, and a graphics processing unit (GPU) 105. The computer 10 further includes a video random access memory (VRAM) 106, a sound controller 106, a basic input/output system-read only memory (BIOS-ROM) 107, a local area network (LAN) controller 108, a hard disk drive (HDD) 109, and an optical disc drive (ODD) 110. Still further, the computer 10 includes a USB controller 111A, a card controller 111B, a wireless LAN controller 112, an embedded controller/keyboard controller (EC/KBC) 113, and an electrically erasable programmable ROM (EEPROM) 114.

The CPU 101 is the processor that controls the other components of the computer 10. The CPU 10 executes the operating system (OS) 201 and the various application programs, such as a photomovie creation application program 202, all having been loaded from the HDD 109 into the main memory 103. The photomovie creation application program 202 is software that plays back the various digital contents stored in, for example, the HDD 109. The photomovie creation application program 202 includes a moving-picture generating function. This function generates moving pictures (e.g., photomovies and slide shows) by using the digital contents such as photographs, which are stored in, for example, the HDD 109. The moving-picture generating function includes a function of analyzing the digital contents used to generate moving pictures. The photomovie creation application program 202 plays back any moving picture generated from the digital contents, and displays the moving picture so generated to the LCD 17.

The CPU 101 also executes the BIOS stored in the BIOS-ROM 107. The BIOS is a program which controls the hardware components of the computer 10.

The north bridge 102 is a bridge device connecting the local bus of the CPU 101 to the south bridge 104. The north bridge 102 includes a memory controller that controls the main memory 103. The north bridge 102 further includes the function of performing communication with the GPU 105 through, for example, a serial bus of the PCI EXPRESS Standard.

The GPU 105 is the display controller which controls the LCD 17 that is used as a display monitor of the computer 10. The GPU 105 generates a display signal, which is supplied to the LCD 17.

The south bridge 104 controls the devices provided on the peripheral component interconnect bus (PCI) and low pin count (LPC) bus, both extending in the computer 10. The south bridge 104 incorporates an integrated drive electronic (IDE) controller, which controls the HDD 109 and ODD 110. Further, the south bridge 104 includes the function of performing communication with the sound controller 106.

The sound controller 106 is a sound source device, and outputs audio data to the speakers 18A and 18B, which generate sound from the audio data. The LAN controller 108 is a wired communication device which executes wired communication of, for example, IEEE 802.3 Standards. By contrast, the wireless LAN controller 112 is a wireless communication device which executes wireless communication of, for example, IEEE 802.11g Standards. The USB controller 111A executes communication with an external device of, for example, USB 2.0 Standards, which is connected to it by the USB connector 19. The USB controller 111A is used to receive video data from a digital camera, for example. The card controller 111B executes writing data into, or reading data from, a memory card, such as a secure digital (SD) card (registered trademark), inserted in the card slot provided in the computer main unit 11.

The EC/KBC 113 is a one-chip microcomputer including an embedded controller and a keyboard controller. The embedded controller controls power, and the keyboard controller controls the keyboard 13 and touch pad 16. The EC/KBC 113 includes the function of turn the computer 10 on or off as the user operates the power button 14.

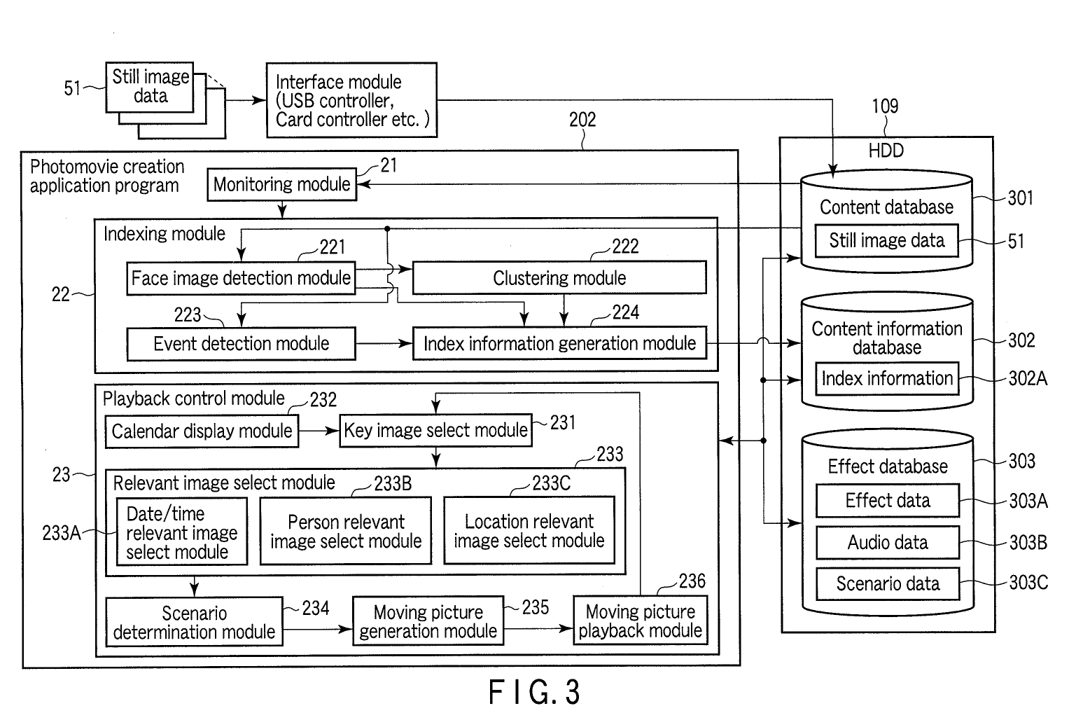

The function configuration of the photomovie creation application program 202 will be explained with reference to FIG. 3. Of the functions the photomovie creation application program 202 executes, the function of generating moving pictures will be described. This moving-picture generating function generates a moving picture (i.e., photomovie) or a slide show by using a plurality of still images stored in a prescribed directory (folder) provided in the HDD 109. The moving picture or slide show, thus generated, is played back. Still image data items 51 are digital photos or a still image file (e.g., JPEG file), for example.

The term “photomovie” means a moving picture (movie) composed of a plurality of still images (e.g., photos). To play back the photomovie, various effects or transitions are applied to a still image group. The still image group, with effects or transitions applied, is played back together with music. The photomovie creating application program 202 can automatically extract a still picture group related to a particular still image (i.e., key image), can generate a photomovie from the still picture group, and can play back the photomovie so generated. The term “slide show” means a method of sequentially displaying still images, one by one. In the slide show, effects or transitions can be applied to each still image.

The photomovie creation application program 202 monitors a folder (i.e., photo folder) stored in the HDD 109 and designated by the user. On detecting one or more new still images (photo files) in the photo folder, the photomovie creation application program 202 starts performing indexing on the new still images and initiates, at the same time, the slide show, displaying the new still image, one by one. The user can enjoy the slide show, seeing the new still images, until the indexing is completed. That is, the user does not feel he or she is kept waiting until the indexing is completed.

When the indexing is completed, the photomovie creation application program 202 generates a photomovie from one or more new still images. The photomovie generated is displayed. This satisfies the user who wants to view the new still images immediately. In this case, the photomovie may be generated from one or more new still images only, or from one or more new still images and still images extracted from the photo folder, which related to the one or more new still images.

Furthermore, after the photomovie (first photomovie) has been generated from one or more new still images, the still images related to these new still images may be extracted from the photo folder, and another photomovie (second photomovie) may be generated from the new still images extracted from the photo folder and then displayed.

The user can therefore enjoy a slide show (seeing the new still images, one after another, which need not have index information), once the new still images have been stored into the photo folder in the electronic apparatus according to this embodiment. At the same time the slide show starts, the photomovie creation application program 202 starts executing indexing on the new still images. This does not make the user feel he or she is kept waiting for the completion of indexing. That is, as soon as the indexing is completed, a photomovie generated from the new still images is played back, and the user can immediately enjoy seeing the photomovie generated from the new still images. The configuration that starts executing various processes when new still image are stored into the photo folder will be described later in detail.

A photomovie is generated on the basis of one still image (key image) the user has selected. First, still images related to the key image are automatically extracted from the photo folder. Then, a photomovie is generated from the still images so extracted. As photo-movie generating conditions, a style, music, and a person of interest (face image) may be selected. The style selected determines the method of extracting still images from which to generate a photomovie and, also, the effects, transitions, etc., to be applied to the still images extracted. With the conventional electronic apparatus, the user designates still images from which to generate a movie. In the electronic apparatus according to this embodiment, the photomovie creation application program 202 automatically extracts still images from which to generate a photomovie. The resultant photomovie may therefore include photos that the user has not expected at all.

In the process of extracting still images, still images better than others in terms of the smile degree and sharpness of face images may be extracted from the photo folder. Further, the person of each face image may be recognized by executing face clustering, and photos each containing the face image of the person selected or photos each containing the face image of another person related to the person selected may be extracted from the photo folder. Moreover, an event-grouping technique may be utilized to classify the photos into groups each related to an event. In this case, the relevancy between any two events may be inferred from the relation between the persons participating in both events, and the result of inference may be used to extract some photos from the photo folders. For example, events in which the same person has participated may be inferred as relevant to each other. Further, for example, if Person A and Person B appear together in many photos (if coexistence frequency is high), the event in which Person A has participated can be inferred as relevant to the event in which Person B has participated.

The photo-movie generating application program 202 includes a monitoring module 21, an indexing module 22, and a playback control module 23.

The monitoring module 21 monitors the content database 301 provided in the HDD 109 at all times. Therefore, the monitoring module 21 determines whether or not new still image data items 51 have been stored into the content database 301 through an interface module such as the USB controller 111A or the card controller 111B. The content database 301 is equivalent to a prescribed directory (i.e., photo-folder mentioned above). The still image data items 51 stored in the content database 301 are used as content candidates for the moving picture (photomovie) and slide show. The content database 301 may store not only still images but also moving pictures as the content candidates for, for example, a short movie.

The indexing module 22 analyzes a plurality of still image data items 51 stored in the content database 301, and generates index information 302A representing the attributes of the respective still image data items 51. The indexing module 22 starts indexing, triggered by, for example, the storage of one or more still image (photo files) into the content database 301. That is, when one or more new still images are stored into the content database 301, the indexing module 22 generates index information about the new still images.

The indexing module 22 includes a face recognition function, too. The index information 302A includes the results of recognizing face images contained in the still image data items 51.

The indexing module 22 includes a face image detection module 221, a clustering module 222, an event detection module 223, and an index information generation module 224.

The face image detection module 221 extracts face images from the still image data items 51 that should be indexed (e.g., new still images stored into a photo folder). The face images can be detected by, for example, first analyzing the characteristics of the still image data items 51 and then searching for regions having characteristic similar to a face-image characteristic sample prepared before. The face-image characteristic sample is characteristic information that has been acquired by statistically processing the facial characteristics of many persons. In the process of extracting face characteristics, the regions corresponding to the face images contained in the still image data items 51 are detected, and the positions (coordinates) and sizes of these regions are also detected.

Further, the face image detection module 221 analyzes the face images thus extracted. The face image detection module 221 calculates the smile degree, sharpness, frontality, etc. of each face image extracted. The smile degree is an index that indicates how much the person smiled when photographed. The sharpness is an index that indicates how clear the face image is (that is, not blurred). The frontality is an index that indicates how much the person's face is directed toward the front. The information about the face images so analyzed is output from the face image detection module 221 to the clustering module 222.

The clustering module 222 executes clustering on the face images detected, thereby classifying the face images in accordance with the characteristic similarity. Any face images similar in characteristic are therefore recognized as pertaining to the same person. On the basis of the clustering results, the clustering module 222 assigns identification data items (personal IDs) to the face images. More precisely, a personal ID is assigned to the face images of one person. The clustering module 222 outputs the attributes of each face image (i.e., smile degree, sharpness, frontality, and personal ID) to the index information generation module 224.

The event detection module 223 detects an event associated with the still image data items 51 to be indexed. More specifically, in accordance with the dates and times (photographing dates and times) when the still images were acquired, the event detection module 223 classifies these still image data items 51 into groups, each consisting of still images acquired within a period (e.g., one day) and therefore regarded as photographed at an event. Then, the event detection module 223 assigns event identification data items (event IDs) to the still image data items 51 to be indexed. The event IDs, each assigned to still images acquire at the same event, are output from the event detection module 223 to the index information generation module 224.

The index information generation module 224 generates index information 302A from the data coming from the face image detection module 221, clustering module 222 and event detection module 223.

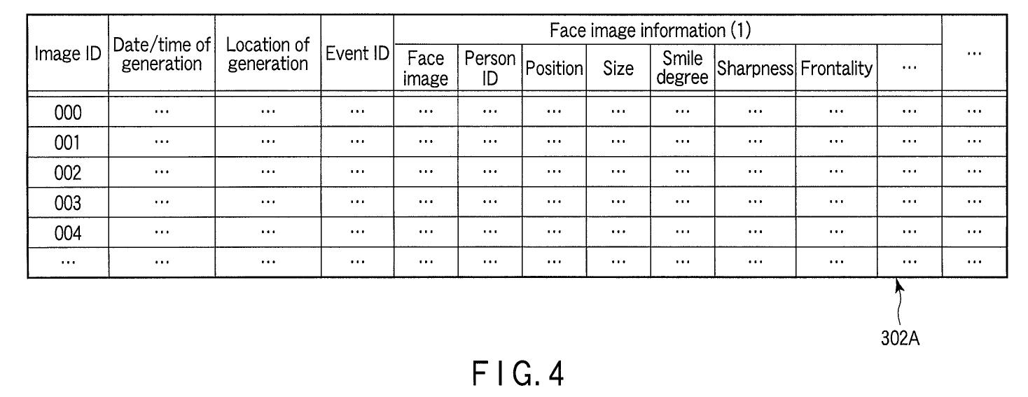

FIG. 4 shows exemplary index information 302A. Index information 302A contains entries corresponding to still image data items 51, respectively. Each entry includes, for example, image ID, date/time of generation (photographing date/time), location of generation (photographing location), event ID and face image information. Of the entry associated with a certain still image, the image ID is the identification data specific to the still image, the date/time of generation indicates the date and time when the still image was generated, and the location of generation indicates the location where the still image was generated. The date/time of generation and the location of generation are, for example, data items added to the still image data. The location of generation is data representing the position detected by, for example, a global positioning system (GPS) receiver detected when the still image data was generated (for example, when the photo corresponding to the still image data was taken). The event ID is the ID data uniquely assigned to the event associated with the still image. The face image information represents the result of recognizing the face images contained in the still image, and includes a face image (e.g., location data indicating the storage location of the face image), personal ID, position, size, smile degree, sharpness and frontality. One still image data item 51 may contain a plurality of face images. In this case, the Index information 302A associated with the still image data item 51 contains face image data items about the respective face images.

The index information generation module 224 stores the index information 302A into the content information database 302.

So configured as described above, the indexing module 22 generates index information 302A associated with the still image data input. The index information 302A can be stored in the content information database 302.

In accordance with the index information 302A, the playback control module 23 extracts a still image group associated with a still image (key image) selected, from the still image data items 51 stored in the content database 301. The still image group extracted is used, whereby a photomovie or a slide show is generated and played back. The playback control module 23 includes, for example, a key image select module 231, a calendar display module 232, a relevant image select module 233, a scenario determination module 234, a moving picture generation module 235, and a moving picture playback module 236.

The key image select module 231 selects a key image (key still image) from the still image data items 51 stored in the content database 301. The key image select module 231 can also select, as a key image, any still image included in the moving picture (i.e., photomovie) or slide show being played back. That is, the key image select module 231 selects, as a key image, one of the images constituting the photomovie or slide show being played back, which the user has designated. If the user designates no key images while the photomovie or slide show is being played back, the key image select module 231 may select, as a key image, the last still image included in the photomovie or slide show.

The key image select module 231 may select the key image, by using a calendar screen arranging the still image data items 51. That is, using the calendar screen, the key image select module 231 can select the still image the user has designated, as a key image.

Alternatively, the key image select module 231 can designate the face image the user has selected, as a key face image. In this case, the still image data items 51 associated with the person corresponding to the key face image are extracted from the content database 301 and used to generate a moving picture (a photomovie) or a slide show.

The relevant image select module 233 selects (extracts) the still images relevant to the key image (key face image) from the still image data items 51 stored in the content database 301. The still images relevant to the key image are those that are relevant to, for example, date, time, person and location. The relevant image select module 233 extracts the still images relevant to the key image by using the index information 302A stored in the content information database 302, for example. The relevant image select module 233 includes a date/time relevant image select module 233A, a person relevant image select module 233B, and a location relevant image select module 233C.

The date/time relevant image select module 233A selects (extracts) the still images relevant to the data and time the key image was generated, from the still image data items 51 stored in the content database 301. On the basis of, for example, the index information 302A, the date/time relevant image select module 233A selects (extracts) the still images generated during the same period (for example, day, month, season or year) the key image was generated. The date/time relevant image select module 233A further selects (extracts), on the basis of the index information 302A, the still images generated during a period (day, month, season or year) different from the period the key image was generated (for example, on the same day or in the same month exactly one year before or after).

The person relevant image select module 233B selects (extracts) still images relevant to the key face image (i.e., face image contained in the key image) from the still image data items 51 stored in the content database 301. The still images relevant to the key face image are, for example, a still image containing the face image of the person identical to the key face image and a still image containing the face image of another person relevant to the person of the key face image. The other person relevant to the person of the key face image is, for example, a person whose face image appears in the still image containing the key face image.

The location relevant image select module 233C selects (extracts) the still images relevant to the location where the key image has been generated, from the still image data items 51 stored in the content database 301.

The scenario determination module 234 determines a scenario for the moving picture (e.g., photomovie) that should be generated. The scenario is information (scenario information) representing the effects and still image attributes that will be applied to the chapters (time segments) of the moving picture to be generated. In other words, the scenario defines both an effect and still image attribute for each time segment called “chapter.”

In this embodiment, 24 scenario information items, for example, are stored in an effect database 303 as scenario data 303C. The scenario determination module 234 determines one of the 24 scenario information items as a scenario that should be used to generate a moving picture (e.g., photomovie). The scenario to be used to generate a moving picture may be determined in accordance with the style the user has selected. That is, the scenario is determined in accordance with the style selected. Eight styles (Happy, Fantastic, Ceremonial, Cool, Travel, Party, Gallery and Biography), for example, are prepared in the present embodiment. Further, three scenario information items are prepared for each style. The scenario determination module 234 automatically selects one of the three scenario information items associated with the style the user has selected, and then determines the scenario information item, which has been automatically selected, as the scenario for the moving picture (e.g., photomovie) that should be generated. Moreover, the scenario determination module 234, not the user, may automatically select any one of the eight styles. In this case, the style to be used may be determined from, for example, the characterizing features (e.g., number of persons, i.e., face images, the smile degree, etc.) of the still image extracted by the relevant image select module 233.

As described above, one of the three scenario information items associated with the style selected is selected as the scenario for the moving picture (e.g., photomovie) that should be generated. In order to select this scenario, a random number, for example, may be utilized. If a random number is used, a different scenario can be used every time to generate a photomovie, even if the user selects the same style. The attributes of the still images used to generate a photomovie change in accordance with the scenario selected and used. Hence, the change of scenario, from one to another, can render it more possible that the user may enjoy seeing a moving image constituted by unexpected still images.

The scenario determination module 234 further determines the music to be applied to the photomovie. In this embodiment, the effect database 303 stores audio data 303B that represents many pieces of music. The scenario determination module 234 determines the music to be applied to the photomovie, in accordance with the style selected or with the characterizing features (e.g., number of persons, i.e., face images, the smile degree, etc.) of the still image extracted by the relevant image select module 233. The music to be applied to the photomovie may be designated by the user.

The moving picture generation module 235 generates a photomovie in accordance with the scenario information the scenario determination module 234 has determined. In order to generate the photomovie, the moving picture generation module 235 extracts at least one still image that agrees in attribute with the still images for the chapters represented by the scenario information. Then, the moving picture generation module 235 generates a photomovie, by allocating the still image, thus extracted, to each chapter.

The moving picture playback module 236 plays back the photomovie by applying the effect correspond to each chapter, which is designated by the scenario information, to the still images allocated to each chapter, using the effect data 303A stored in the effect database 303.

The scenario information determined may be used to determine the order in which to display still images in a slide show. In this case, the moving picture generation module 235 extracts at least one of the still images extracted by the relevant image select module 233, which agrees in attribute to the still images for each chapter represented by the scenario information. Then, the moving picture generation module 235 allocates at least one extracted still image to each chapter. Still images to be used in the slide show and the timing of displaying these still images in the slide show are thereby determined. Before starting the slide show, the effect data 303A may be used to apply effects to the still images.

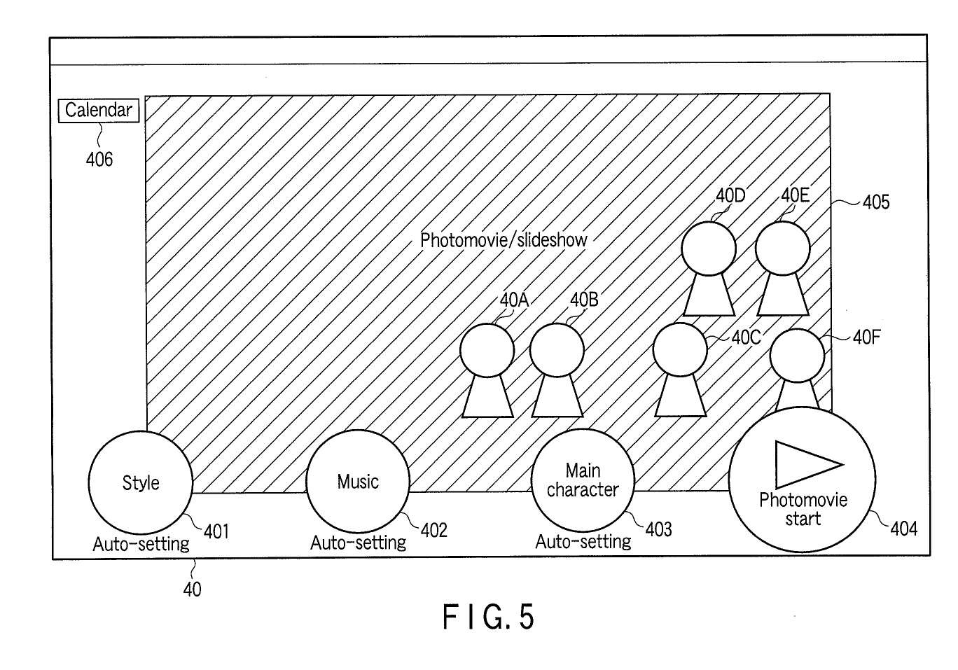

FIG. 5 shows an exemplary main menu screen 40 that may be displayed by using the photomovie creation application 202. The main menu screen 40 shows, for example, a “Style” button 401, a “Music” button 402, a “Main Character” button 403, a “Photomovie start” button 404, a movie playback screen 405, and a “Calendar” button 406.

The movie playback screen 405 is provided to show any photomovie or slide show that has been generated. On the movie playback screen 405, a photomovie or slide show generated by the playback control module 23 (more precisely, moving picture generation module 235) is played back. FIG. 5 shows a photomovie or a slide show, in which six persons 40A to 40F appear.

Assume the user operates a pointing device, clicking the movie playback screen 405, while a photomovie or a slide show is being played back. Then, the photomovie creation application 202 temporarily interrupts the photomovie (or slide show), and designates the image being played back, as a key image. If the image being played back has been generated by synthesizing a plurality of still images, the photomovie creation application 202 may determine one of these still images as a key image. Of these still images, the still image the user has clicked may, of course, be designated as a key image.

The “Main Character” button 403 is a button that should be clicked to select the main character, i.e., one of the persons appearing in the photomovie, who attracts more attention than any other persons. When the “Main Character” button 403 is clicked, the key image select module 231 displays a list of the persons appearing in the key image (i.e., face image selection screen) to the LCD 17. The user first selects the key image using the movie playback screen 405 and then pushes the “Main Character” button 403, instructing that a key face image should be selected.

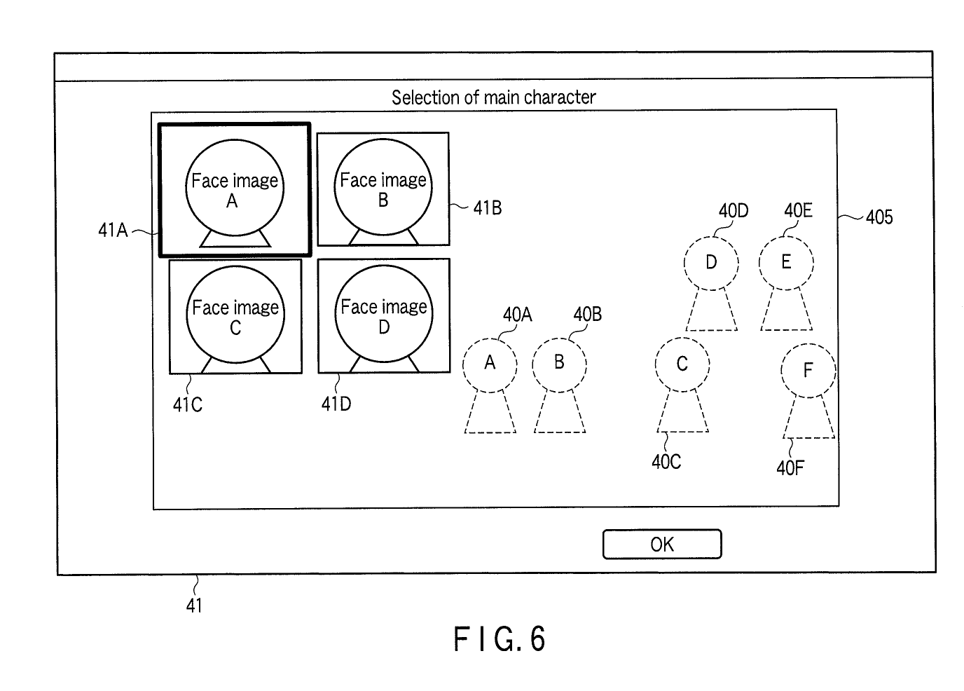

FIG. 6 shows an exemplary main-character selection screen 41 that may be displayed to enable the user to select a face image as a key face image. The main-character selection screen 41 displays a list of the face images (i.e., face images 41A to 41D) that are contained in the key image. The key image select module 231 first selects, from persons 40A to 40F, the persons (e.g., person 40A to 40D), each appearing in still images the number of which is equal to or greater than a threshold value. The key image select module 231 then displays the face images 401A to 41D of the persons 40A to 40D selected on the movie playback screen 405.

The user selects the face image of the person interesting to him or her, from the faces images 41A to 41D displayed on the main-character selection screen 41. The user may select, for example, face image 41A. In this case, the key image select module 231 determines the face image 41A as a key face image (main character). The user may select two or more face images at a time. If the user does not select any face images displayed on the main-character selection screen 41 (that is, if the “Main Character” button 403 is not pushed), the key image select module 231 may select, as a key face image, any one of the face images contained in the key image, which meets particular conditions.

The user may push the “Style” button 401 displayed on the main screen 40 of FIG. 5, in order to select a style for the photomovie. When the “Style” button 401 is pushed, the photomovie creation application 202 displays a style selection screen to the LCD 17. On the style selection screen, eight styles (Happy, Fantastic, Ceremonial, Cool, Travel, Party, Gallery and Biography) are displayed. The user can therefore select one of these styles.

The “Music” button 402 is a button the user may push to select music for the photomovie. When the “Music” button 402 is clicked, the photomovie creation application 202 displays a music list (music selection screen) to the LCD 17. The user can then select any music shown on the music selection screen.

The “Photomovie start” button 404 is a button the user may click to start the generation and playback of a photomovie. When the “Photomovie Start” button 404 is pushed, the photomovie creation application 202 starts generating a photomovie. The photomovie, generated, is displayed on the movie playback screen 405.

The key image select module 231 may use the calendar screen showing the still image data items 51 as described above, thereby selecting a key image. The “Calendar” button 406 is a button the user may push to display the calendar screen.

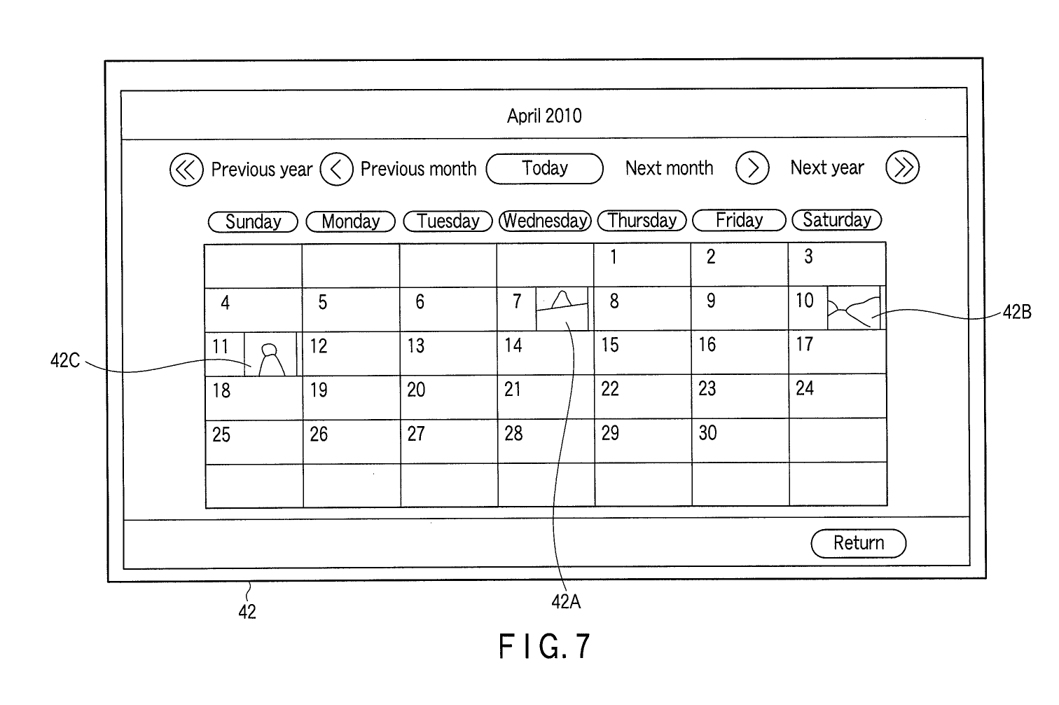

FIG. 7 shows an exemplary calendar screen 42 the LCD 17 may display. On the calendar screen 42, the calendar of the month designated is displayed. Thumbnail images (42A to 42C) are displayed, specifying the days on which still images were generated, respectively. The user may select one of the thumbnail images. Then, the key image select module 231 selects the still image for the thumbnail image selected, as the key image.

A plurality of still image data items 51 may be generated on the same day. In this case, the thumbnail image for one still image data item 51 is displayed, representing all still image data items 51. When this thumbnail image is selected on the calendar screen 42, the key image select module 231 displays a thumbnail list showing the thumbnail images generated on the day to the LCD 17. The user selects one of the thumbnail images in the thumbnail list. The key image select module 231 selects, as the key image, the still image data item 51 associated with the thumbnail image selected, from the thumbnail list. The key image select module 231 can use the main-character selection screen 41, too, to select a key face image after a key image is selected by using the calendar screen 42.

How the process of generating a photomovie proceeds will be explained. A photomovie is generated on the basis of a key image (i.e., image being displayed on the main menu screen 40 or an image selected at the calendar screen 42).

<Image being Displayed on Screen 40 is Used as Key Image>

(1) Click the main screen 40 while the slide show/photomovie is being played back.

(2) Select a style (default set to “Auto-setting”).

(3) Select the music for the photomovie (default set at “Auto-setting”).

(4) Select the person of interest (default set to “Auto-setting”).

(5) Click the “Photomovie start” button 404.

If the user wants to set a style, the music and the person of interest, all to “Auto-setting,” he or she only needs to click the main screen 40, displaying the “Photomovie start” button 404, and click the “Photomovie start” button 404.

<Image Selected at Calendar Screen is Used as Key Image>

(1) Click the “Calendar” button at the main screen 40.

(2) Select the date of photographing the basic photo, displaying a part of the photo.

(3) Select a basic photo from a photo list, and click the “Photomovie start” button 404.

(4) Select a style at the main screen 40 (default set to “Auto-setting”).

(5) Select the music for the photomovie at the main screen 40 (default set at “Auto-setting”).

(6) Select the person of interest (default set to “Auto-setting”).

(7) Click the “Photomovie start” button 404.

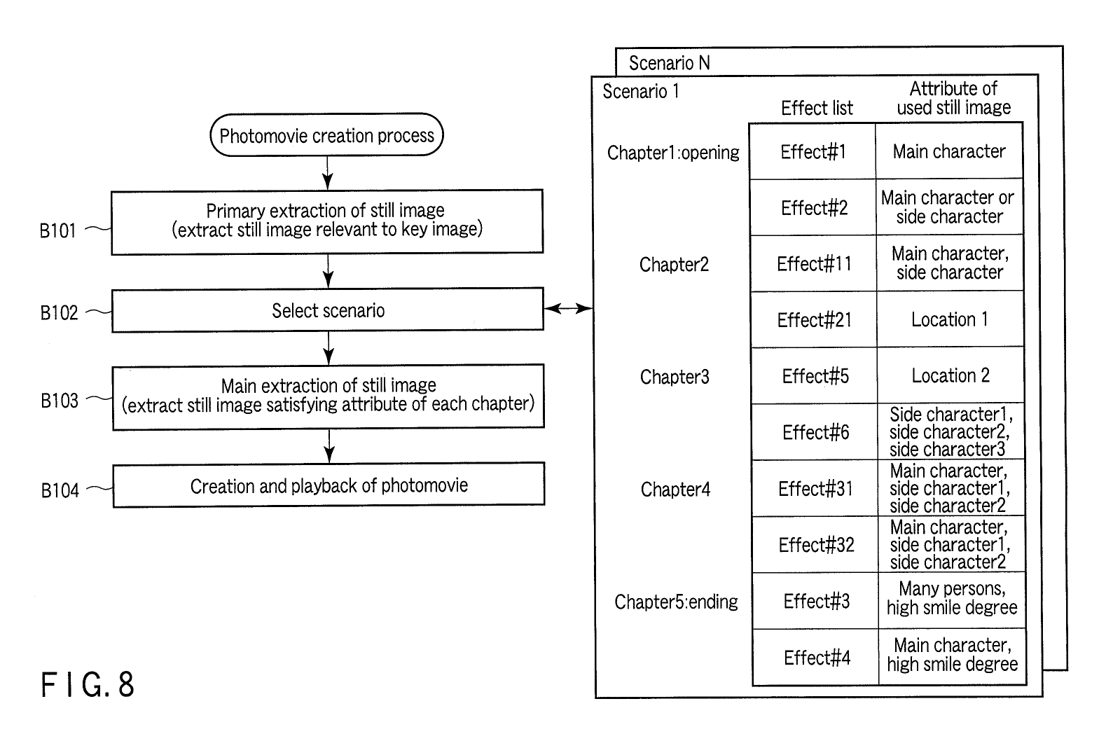

The process of generating a photomovie will be outlined below, with reference to FIG. 8.

First, the photomovie creation application 202 extracts the still images relevant to the key image (key face image) from the content database 301 (Primary extraction), in accordance with the index information (Block B101). The still images extracted by the photomovie creation application 202 in Block B101 from the content database 301 are, for example, those that are relevant to the person selected (i.e., main character).

Next, the photomovie creation application 202 selects a scenario for use in generating the photomovie (Block B102). In Block B102, the photomovie creation application 202 selects one of the scenario information items already prepared, in accordance with the style selected and the characteristic values of the still images extracted in Block B101. Each scenario information item defines the order (i.e., effect string) in which to use effects in the chapters (scenes) constituting a photomovie sequence, and also the attributes of the still images (i.e., still image attributes). The photomovie sequence shown in FIG. 8 is constituted by five chapters (i.e., chapters 1, 2, 3, 4 and 5). The chapter 1 is the opening scene of the photomovie. The chapter 5 is the ending scene of the photomovie. For each chapter, one or more effects (two effects in the photomovie sequence shown in FIG. 8) are defined. Further, a still image attribute is defined for each effect.

As the attribute of each still image, the personal attribute of each person (i.e., face attribute) can be used. The personal attribute is, for example, main character, side character, smile degree, sharpness, and number of characters appearing in the still image. The term “main character” means the person who is the main character in the photomovie, i.e., person of interest (or face of interest). For example, the key face image mentioned above may be determined to be the main character. The term “side character” means another person who is related to the main character. For example, a person who often appears along with the main character in the photomovie may be determined to be the side character. The personal attribute can designate a plurality of support roles. That is, the persons (faces), who frequently appear along with the main character in the photomovie, can be side characters. Not only personal attributes, but also location attributes can be used as still image attributes. The location attributes designate the locations where the still images have been obtained.

The scenario 1 shown in FIG. 8 defines two effects (i.e., effect #1 and effect #2) for the chapter 1, and still image attributes “main character” and “main character OR side character” are associated with the effects #1 and #2, respectively. The still image attribute “main character” indicates that a still image in which the main character appears should be used. The still image attribute “main character OR side character” indicates that a still image in which either the main character or a side character should be used. Some other examples of still image attributes are as follows.

A still image attribute “main character, side character” associated with the effect #1 of the chapter 2, indicates that a still image should be used, in which both the main character and the side character appear. A still image attribute “side character 1, side character 2, side character 3” associated with the effect #6 of the chapter 3 indicates that a still image should be used, in which all three side characters 1, 2 and 3 appear. A still image attribute “many persons, high smile degree” associated with the effect #3 of the chapter 5 indicates that a still image should be used, in which persons as many as, or more persons than, a threshold value appear and having a smile degree equal to or higher than a threshold value. A still image attribute “main character, high smile degree” associated with the effect #4 of the chapter 5 indicates that a still image should be used, in which the main character appears and smiles at a level equal to or higher than a threshold value. Thus, the personal attributes can indicate whether each person to appear in any chapter is the main character, a side character, or both.

Thereafter, the photomovie creation application 202 extracts one or more still images having still image attributes designated by the scenario information (Main extraction), from the still images extracted in Block B101 (Block B103). The photomovie creation application 202 then allocates the still images, so extracted, to the chapters, thereby generating and displaying a photomovie (Block B104). More precisely, in Block B104, the photomovie creation application 202 applies various effects to the still image allocated to each chapter.

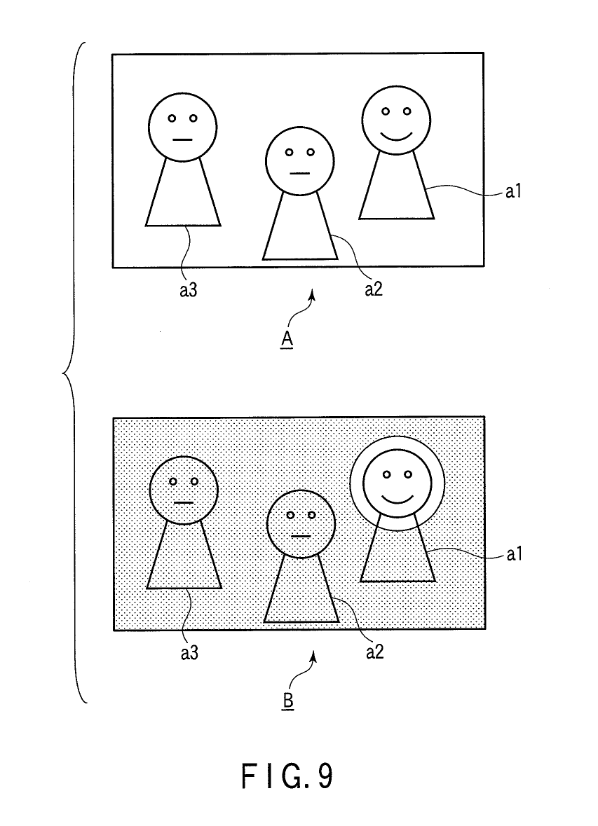

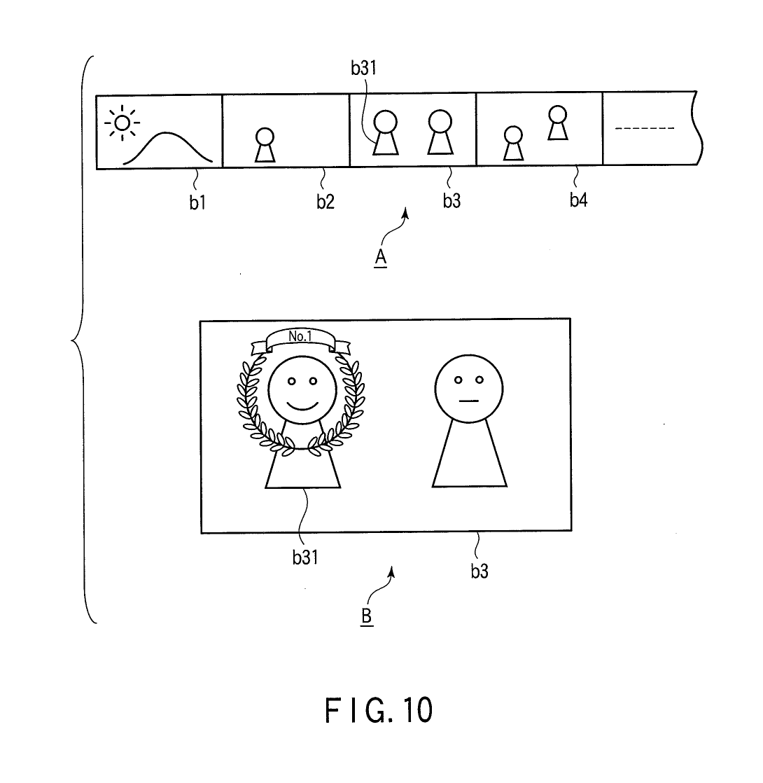

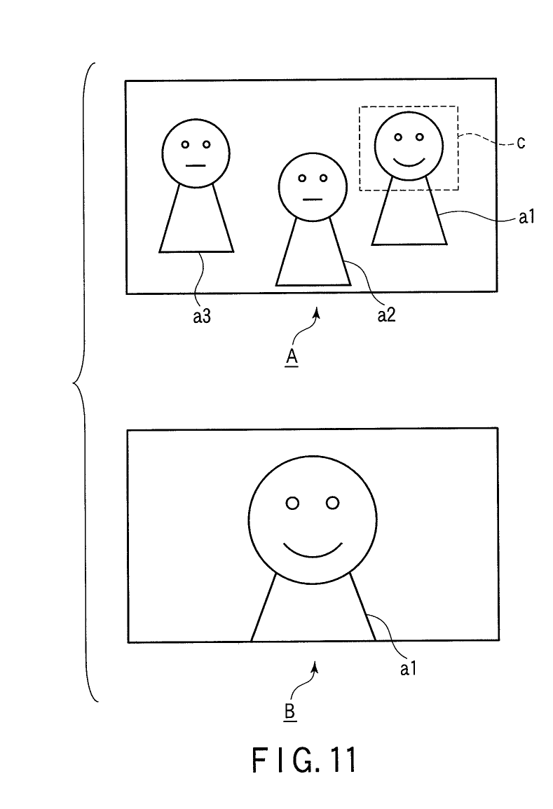

Next, how the index information 302A is used to apply more prominent effects to still images before displaying the still images in the form of, for example, a slide show will be explained with reference to FIG. 9, FIG. 10 and FIG. 11.

As shown in FIG. 4, the index information 302A generated by the indexing unit 22 (on the basis of the results of the processes performed by the face detection module 221, clustering module 222 and event detection module 223) and stored in the content information database 302 includes attribution information such as smile degree, sharpness, frontality, personal ID. Accordingly, to apply effects to a still image, e.g., for emphasizing faces in the still image, this effect is not applied to all faces contained in the still image, but the attribute information is used, thereby applying a more prominent effect to the still images.

Assume that, three persons a1 to a3 exist in a still image as shown in “A” of FIG. 9. Then, the playback control module 23 of the photomovie creation application program 202 selects the face having the highest smile degree from three faces of three person's a1 to a3. Further assume that the face of person a1 has the highest smile level.

Therefore, the playback control module 23 selects the face of person a1 having the highest simile degree and applies, for example, a visual effect to this face, making the face look as if illuminated (as if applied with spot spotlight) as shown in “B” in FIG. 9. As shown in FIG. 4, the index information 302A includes information representing the position and size of each face. In accordance with the position data and the size data, the playback control module 23 applies an effect to the still image, brightening the circular area that is concentric with the selected face, while darkening the other area of the still image. As a result, the selected face looks as if applied with spot spotlight.

That is, the faces of persons a1 to a3 are not processed in the same way. Rather, the face of person a1, which has the highest smile degree, is selected, and a more prominent effect is applied to only the face of person a1. In this case, the face is selected in accordance with the smile degree. Instead, the playback control module 23 may select the face having the highest clearness or the highest frontal degree.

In the instance of FIG. 9, the playback control module 23 selects one of the faces contained in a still image. Instead, the playback control module 23 may select the face having, for example, the highest smile degree from the still images constituting a slide show, and may then apply an effect to only the selected face.

Assume that a slide show shown in “A” in FIG. 10 is displayed. This slide show is constituted by still images b1, b2, b3, b4, . . . . Also assume that the face of person b31 contained in the still image b3 has the highest smile degree of all faces in the still images constituting the slide show.

Then, the playback control module 23 selects the face of person b31, which has the highest smile degree, and applies an effect to the still image b3 containing the face of person b31, displaying an object (i.e., wreath) around the face b3 as shown in “B” in FIG. 10. (The object indicates that the face has the highest smile degree). This effect is applied, displaying a wreath concentric with the selected face, also in accordance with the position data and the size data included in index information 302A.

Thus, various prominent effects can be applied to faces, by utilizing the attribute information about the face included in the index information 302A.

In the instance of FIG. 10, the playback control module 23 selects the face having the highest smile degree from the faces contained in the still images constituting a slide show. In this regard, it should be recalled that the index information 302A includes personal ID as attribute information. Therefore, of the faces of each person appearing in the slide show, the face having the highest simile degree may be selected and an effect may be applied to the face so selected.

Alternatively, of the faces contained in the still images constituting a slide show, faces having higher smile degrees than the others are selected in a prescribed number, and one object may be displayed at each face, indicting a ranking of the smile degree of the face. In the still image in “A” in FIG. 9, for example, three objects indicating the highest smile degree, the second highest smile degree and the third highest smile degree may be displayed at the faces of persons a1, a2 and a3, respectively. Still alternatively, faces having higher smile degrees than the others may first selected and then be displayed, in a slide show, prior to the other faces.

Effects can applied, not only to a slide show in which still images are displayed one after another, but also a photomovie, by utilizing the attribute information, i.e., smile degree, sharpness, frontality, etc. For example, an effect may be applied to the still image shown in “A” in FIG. 11, which contains three persons a1, a2 and a3, thereby changing the still image to a still image shown in “B” in FIG. 11, which contains an enlarged face of person a1 only (selected as having the highest smile degree). In this case, the image of person a1 appears as if zoomed in.

Moreover, the attribute information included in the index information 302A can be used to apply various prominent effects to a slide show and a photomovie.

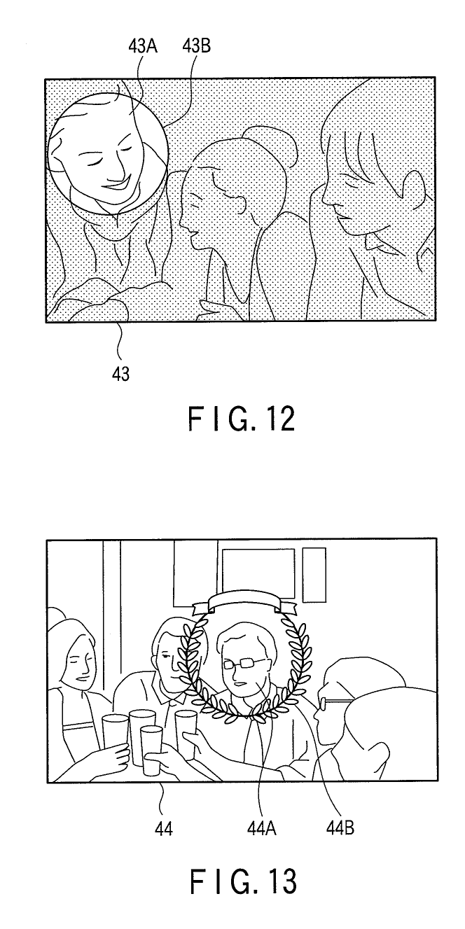

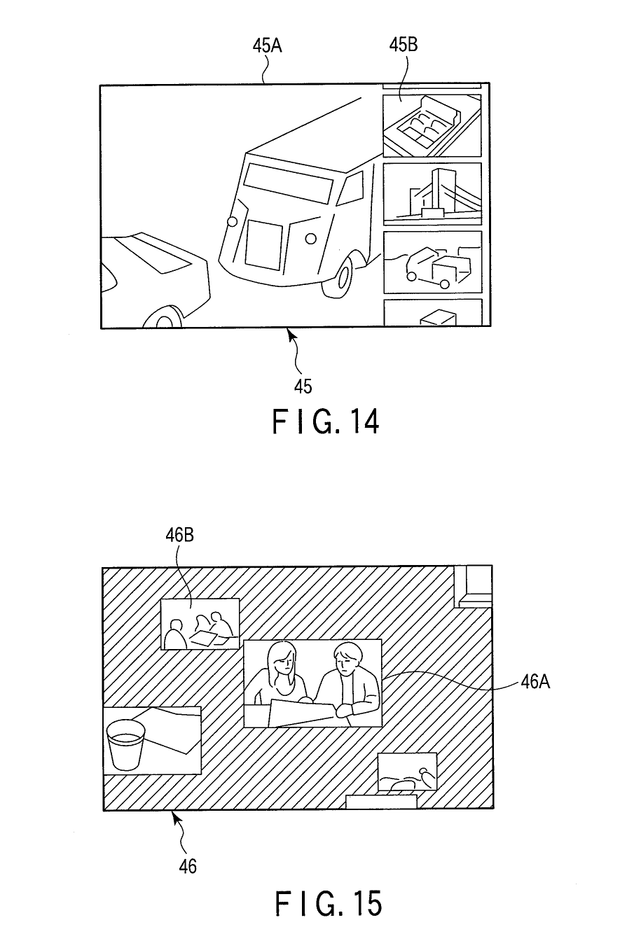

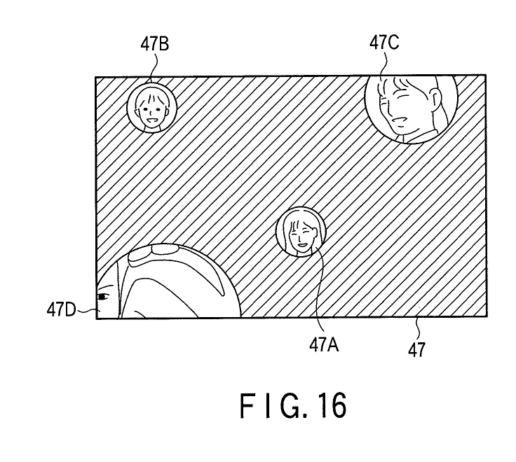

FIG. 12, FIG. 13, FIG. 14, FIG. 15 and FIG. 16 show several exemplary images that have some effects applied by the photomovie creation application 202.

FIG. 12 and FIG. 13 show two effects, respectively, which are applied to two still images, respectively, each effect emphasizing the face image of a particular person appearing in one still image. In the still image 43 of FIG. 12, effect 43B highlights the face image of a person 43A. Assume that in the still image 43, the person 43A is the main character, whereas the two other persons are side characters. Then, an effect can be applied to the still image, first highlighting “side character 1,” then highlighting “side character 2,” and finally highlighting “main character.” In the still image of FIG. 13, effect 44B, i.e., a wreath (object) is illustrated, surrounding the face image of person 44A.

FIG. 14 and FIG. 15 show screens 45 and 46, respectively, to which two effects are applied, respectively. In the still image 45 of FIG. 14 and the still image 46 of FIG. 15, small images 45B are arranged, representing the location, size, motion, etc. of the object 45A and 46A, respectively.

FIG. 16 shows a screen 47, respectively, to which an effect is applied. More precisely, face images 47A to 47D extracted from still images, respectively, are displayed on the screen 47, and keep moving on the screen 47.

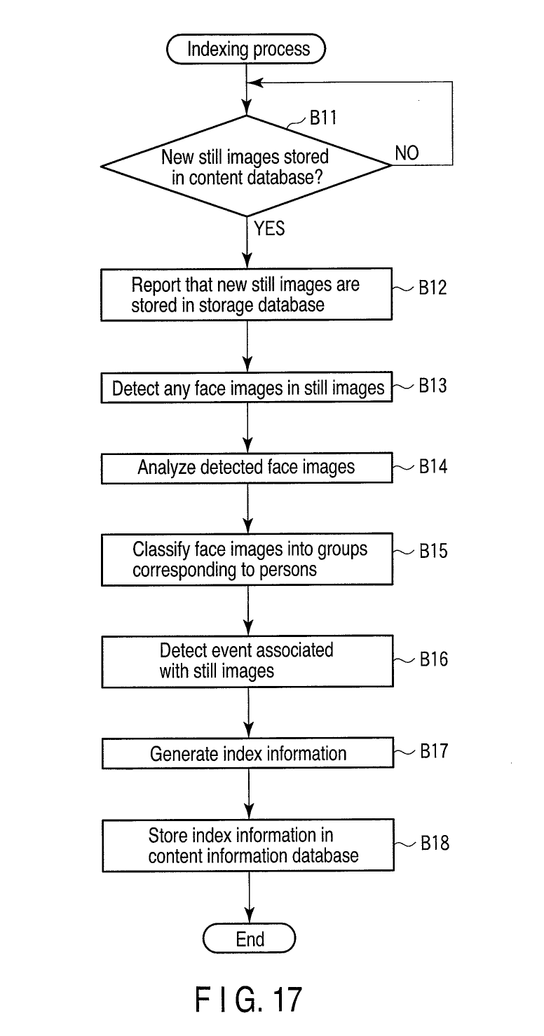

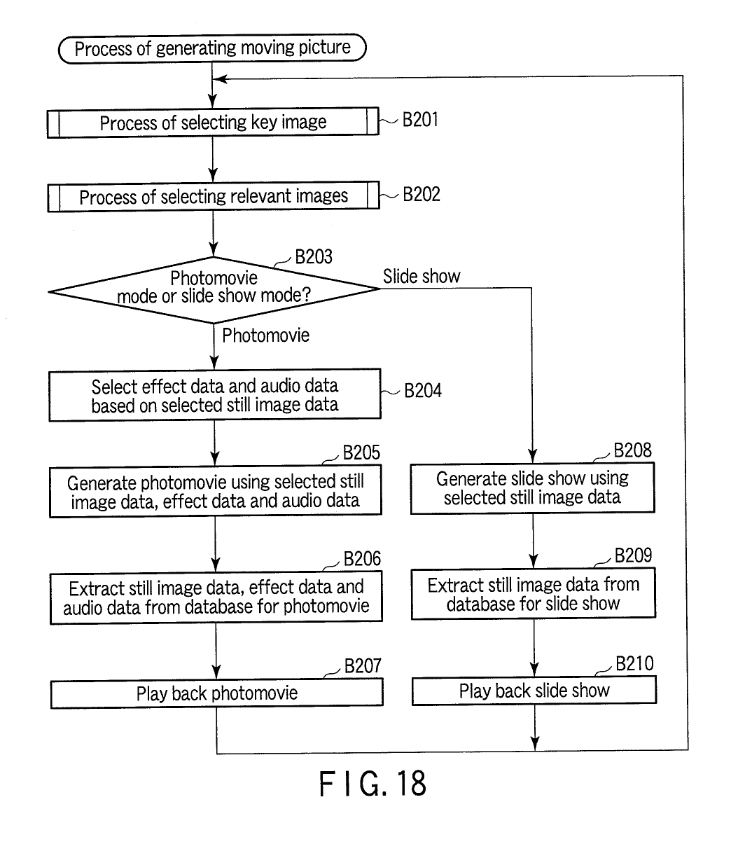

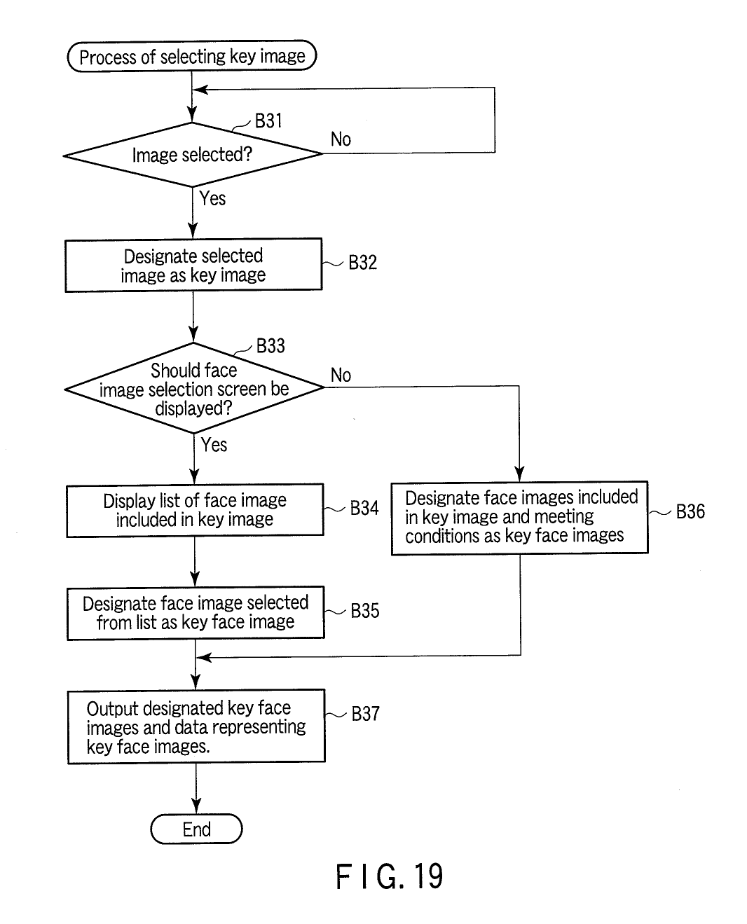

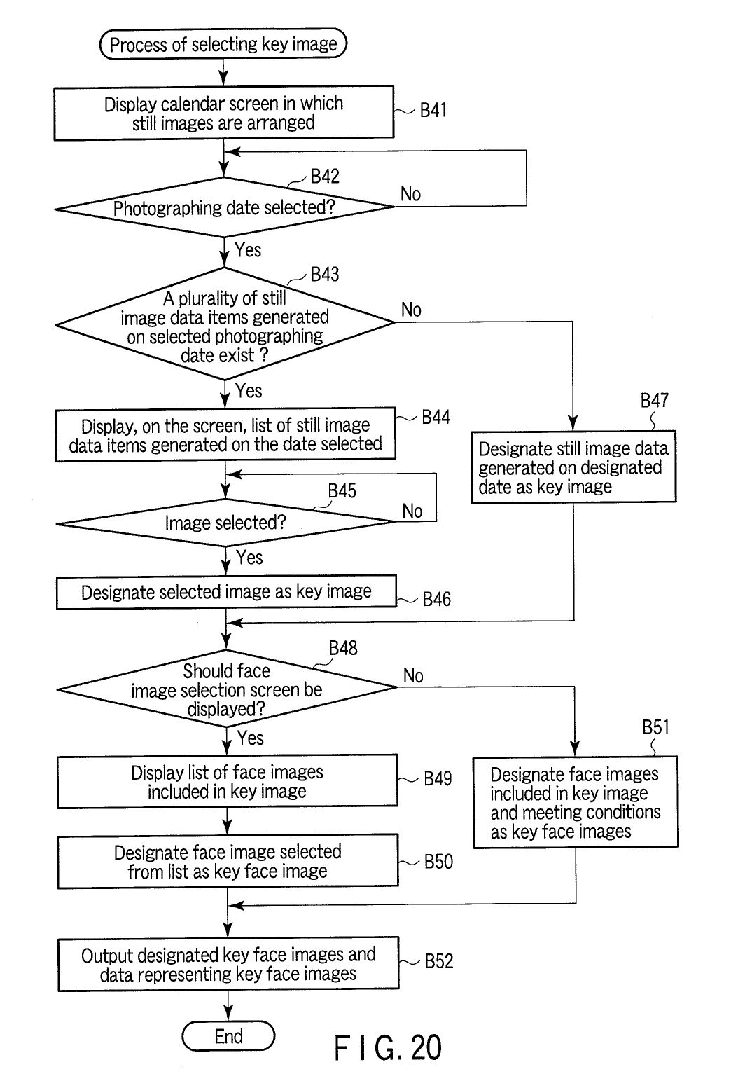

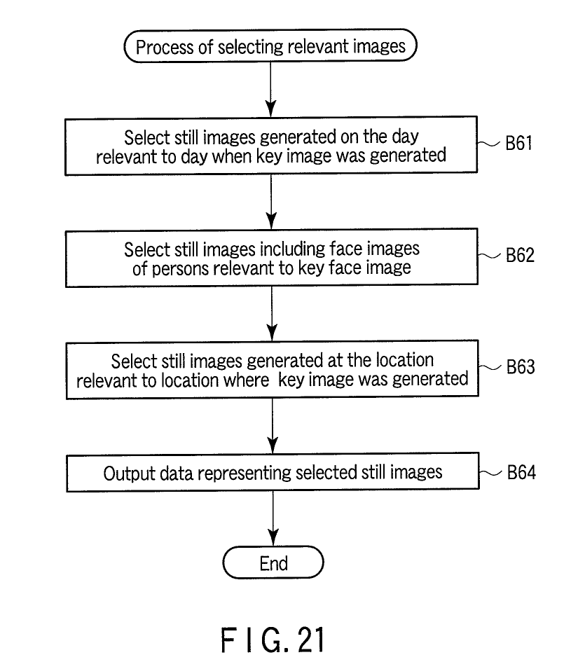

The operating sequence of the photomovie creation application 202 will be explained with reference to the flowcharts of FIG. 17, FIG. 18, FIG. 19, FIG. 20 and FIG. 21.

FIG. 17 is an exemplary flowchart showing an example of a sequence of the indexing process executed by the photomovie creation application 202.

First, the monitoring module 21 monitors the content database 301 at all times, determining whether new still images (still image data items) 51 have been stored in the content database 301 provided on the HDD 19 (Block B11). If no new still images data items 51 are stored in the storage database 301 (NO in Block B11), the process returns to Block B11, in which the monitoring module 21 determines again whether new still image data items 51 have been stored in the content database 301.

If new still images data items 51 are stored in the storage database 301 (YES in Block B11), the monitoring module 21 informs the indexing module 22 that the new still images data items 51 are stored in the storage database 301 (Block B12).

The face image detection module 221 detects any face images contained in the still image data items 51 (Block B13). Then, the face image detection module 221 detects the regions corresponding to the face images of the persons appearing in the still images (represented by the still image data items 51), and also detects the locations and sizes of the face images. Next, the face image detection module 221 analyzes the face images it has detected (Block B14). Further, the face image detection module 221 calculates the smile degree, sharpness, frontality, etc. of each face image. The information representing the face images detected is output from the face image detection module 221 to the clustering module 222.

The clustering module 222 executes clustering on the face images detected by the face image detection module 221, classifying the face images into groups, each pertaining to one person (Block B15). The clustering module 222 then assigns identification data items (personal IDs) of the persons to the respective face images. Then, the clustering module 222 outputs the data items representing the face images detected by the face image detection module 221 and the personal IDs assigned to the face images, to the index information generation module 224.

The event detection module 223 detects the event associated with the still image data items 51 (Block B16). The event detection module 223 assigns the identification data (event ID) of the event detected, to the still image data items 51. The event ID assigned to the still image data items 51 is output from the event detection module 223 to the index information generation module 224.

The index information generation module 224 generates index information 302A from the results of the processes executed in the face image detection module 221 and clustering module 222 (Block B17). The index information 302A includes generation date/time, generation location and event ID of the still image data items 51, and face image information indicating a face image containing the still image data items 51. The face image information also contains a face image (storage location of the data representing the face image), personal ID, location, size, smile degree, sharpness and frontality. If any still image contains a plurality of face images, the index information 302A will include a plurality of face image data items representing these face images. The index information generation module 224 stores the index information 302A into the content information database 302 (Block B18).

Thus, the still image data items 51 input by the photomovie creation application 202 are stored into the content database 301, and the index information 302A associated with the still image data items 51 is stored into the content information database 302.

FIG. 18 is an exemplary flowchart showing an example of sequence of the moving-picture generating process executed by the photomovie creation application 202. The photomovie creation application 202 plays back either a photomovie or a slide show.

First, the key image select module 231 executes a key-image selecting process (Block B201). More precisely, the key image select module 231 selects a key image from the still image data items 51 stored in the content database 301. The key image so selected will be used as an extraction key for extracting the still images data items 51 from which to generate a moving picture (photomovie or slide show) that should be played back. The key image select module 231 outputs the data representing the key image to the relevant image select module 233. How the key image is selected will be explained later in detail, with reference to FIG. 19 and FIG. 20.

Next, the relevant image select module 233 executes a related image selecting process, by using the key image selected by the key image select module 231 (Block B202). That is, the relevant image select module 233 selects still image data items 51 relevant to the key image, from the content database 301. The still image data items 51 relevant to the key image are those that are relevant to the key image in terms of, for example, data/time, person or location. The still image data items 51 relevant to the key image are output from the relevant image select module 233 to the scenario determination module 234. The sequence of the relevant image selecting process will be explained later in detail, with reference to FIG. 21.

The scenario determination module 234 determines whether the display mode is photomovie mode or slide show mode (Block B203). The display mode indicates which type of a moving picture should be played back, a photomovie or a slide show. The display mode can be switched by the user. Alternatively, a moving picture linked to a preset display mode may be automatically played back. Still alternatively, the display mode may be switched in accordance with specific conditions.

If the display mode is found to be photomovie mode (“Photomovie” in Block 203), the scenario determination module 234 selects the effect data 303A and audio data 303B in accordance with the still image data items 51 selected by the relevant image select module 233 (Block B204). That is, the scenario determination module 234 selects the effect data 303A and the audio data 303B, which are appropriate for the still image data items 51 selected. The scenario determination module 234 outputs the still image data items 51, effect data 303A and audio data 303B, all selected, to the moving picture generation module 235.

The moving picture generation module 235 uses the still image data items 51 selected by the relevant image select module 233, and the effect data 303A (scenario data 303C) and audio data 303B selected by the scenario determination module 234, thereby generating a photomovie (Block B205). The photomovie so generated is output from the moving picture generation module 235 to the moving picture playback module 236.

In accordance with the photomovie generated by the moving picture generation module 235, the moving picture playback module 236 extracts the still image data items 51 from which to generate a photomovie, from the content database 301, and also the effect data 303A and audio data 303B, both to be used in the photomovie, from the effect database 303 (Block B206). Using the still image data items 51, effect data 303A and audio data 303B extracted, the moving picture playback module 236 plays back the photomovie to display it at the LCD 17 (Block B207). The operation then returns to the process of selecting the key image (Block B201). In Block B201, the key image select module 231 selects, as a new key image, one of the still image data items 51 from the photomovie being displayed, for example.

If the display mode is found to be the slide show mode (“Slide show” in Block 203), the moving picture generation module 235 generates a slide show, by using the still image data items 51 selected by the relevant image select module 233 (Block B208). The slide show, thus generated, is output from the relevant image select module 233 to the moving picture playback module 236.

In accordance with the slide show generated by the moving picture generation module 235, the moving picture playback module 236 extracts the still image data items 51 from which to generate a slide show, from the content database 301 (Block B209). Using the still image data items 51, the moving picture playback module 236 plays back the slide show and displays the slide show to the LCD 17 (Block B210). In the slide show, the still image data items 51 are sequentially displayed at prescribed intervals. The operation then returns to the process of selecting the key image (Block B201). In Block B201, the key image select module 231 selects, as a new key image, one of the still image data items 51 from the slide show being displayed, for example.

As the above-mentioned processes are performed, the photomovie creation application 202 can display a slide show or a photomovie, either using the still image data items 51 relevant to the key image. The use of the still image data items 51 relevant to the key image can provide the user with a moving picture that contains unexpected still images, etc.

The flowchart of FIG. 19 shows an exemplary sequence of the key-image selecting process (Block B201) performed by the key image select module 231. Assume that a key image is selected from the moving picture (photomovie or slide show) being displayed on the screen of the LCD 17.

First, the key image select module 231 determines whether an image has been selected from the moving picture being displayed (Block B31). If any image in the moving picture is found to have been clicked, the key image select module 231 determines that the image clicked has been selected as a key image. If no images are selected (NO in Block B31), the process returns to Block B31, in which the key image select module 231 determines again whether an image has been selected. If an image is selected (YES in Block B31), the key image select module 231 designates this image as a key image (Block B32).

Next, the key image select module 231 determines whether the main-character selection screen 41 should be displayed or not (Block 33). When a button is pushed, instructing the displaying of the main-character selection screen 41, the key image select module 231 determines that the main-character selection screen 41 should be displayed. When a button is pushed, instructing the selection of a key image, the key image select module 231 determines that the main-character selection screen 41 should not be displayed.

If it is determined that the main-character selection screen 41 should be displayed (YES in Block B33), the key image select module 231 displays the main-character selection screen 41 (Block B34). The main-character selection screen 41 is, for example, a screen that displays a face image list showing the face images contained in the key image selected. The user selects the face image of the person of interest (main character) from the face image list. The key image select module 231 then designates the face image selected at the main-character selection screen 41 (from the face image list), as a key face image (Block B35). A plurality of face images may be selected, not only one face image, at the main-character selection screen 41.

It may be determined that the main-character selection screen 41 should not be displayed (NO in Block B33). In this case, the key image select module 231 designates all face images contained in the key image, as key face images (Block B36). The key image select module 231 may select those of the face images contained in the key image, which meet various conditions such as location, size and sharpness, and may then designate these face images as key face images.

After selecting a key face image in Block S35 or in Block B36, the key image select module 231 outputs the data representing the key image and the key face images to the relevant image select module 233 (Block B37).

Thus, the key image select module 231 uses not only the moving picture (photomovie) or the slide show being played back, but also the main-character selection screen 41, thereby to select the key image and the key face image, in accordance with which still image data items 51 are extracted. The relevant image select module 233 selects, from the content database 301, still image data items 51 relevant to the key image and key face image based on the selected key image and key face image.

The flowchart of FIG. 20 shows another exemplary sequence of the key-image selecting process that the key image select module 231 performs (Block 201 shown in FIG. 22). Assume that the calendar screen 42 is used to select a key image.

At first, the calendar display module 232 displays the calendar screen 42, in which the still image data items 51 are arranged in the order they have been generated (Block B41). For example, the calendar display module 232 displays thumbnail images at the dates displayed on the calendar screen 42. Each thumbnail image shows the date of photographing the associated still image. If two or more still image data items 51 have the same photographing date, the calendar display module 232 displays only one thumbnail image (representative thumbnail image) for these still data items 15. The user may select any one of the thumbnail images displayed on the calendar screen 42, thereby to designate the date of photographing the associated still image or images.

Next, the calendar display module 232 determines whether a photographing date has been selected or not (Block B42). For example, the calendar display module 232 determines that a photographing date is selected when the data is clicked on the calendar screen 42. If no photographing dates have been selected (NO in Block B42), the process returns to Block B42, in which the calendar display module 232 determines again whether a photographing date has been selected or not.

If a photographing date has been selected (YES in Block B42), the calendar display module 232 determines whether a plurality of still image data items 51 have been generated on the selected photographing date (Block B43). If a plurality of still image data items 51 have been generated on the selected photographing date (YES in Block B43), the calendar display module 232 displays, on the screen, a list of the thumbnail images associated with these still image data items 51 (Block B44). The calendar display module 232 then determines whether a thumbnail image has been selected from the list displayed (Block B45). If no thumbnail images have been selected from the list (NO in Block B45), Block B45 is repeated, wherein the calendar display module 232 determines again whether a thumbnail image has been selected from the list displayed. If a thumbnail image has been selected from the list (YES in Block B45), the key image select module 231 designates the selected thumbnail image as a key image (Block B46).

If a plurality of still image data items 51 were not generated on the selected date (that is, if only one still image data item 51 was generated on that date) (NO in Block B43), the key image select module 231 designates the sole still mage data item 51 generated on that date, as a key image (Block B47).

After selecting a key image in Block B46 or Block B47, the key image select module 231 determines whether the main-character selection screen 41 should be displayed or not (Block B48). For example, when a button is pushed, instructing the displaying of the main-character selection screen 41, the key image select module 231 determines that the main-character selection screen 41 should be displayed. For example, when a button is pushed, instructing the selection of a key image, the key image select module 231 determines that main-character selection screen 41 should not be displayed.

On determining that the main-character selection screen 41 should be displayed (YES in Block B48), the key image select module 231 displays the main-character selection screen 41 (Block B49). The main-character selection screen 41 is, for example, a screen that displays a face image list showing the face images contained in the key image selected. The user selects the face image of the person of interest (main character) from the face image list. The key image select module 231 then designates the face image selected at the main-character selection screen 41 (from the face image list), as a key face image (Block B50). A plurality of face images may be selected, not only one face image, at the main-character selection screen 41.

It may be determined that the main-character selection screen 41 should not be displayed (NO in Block B48). In this case, the key image select module 231 designates, as key face images, those of the face images contained in the key image, which meet prescribed conditions (Block B51). For example, the key image select module 231 may select those of the face images contained in the key image, which meet various conditions such as location, size and sharpness, and may then designate these face images as key face images.

After selecting a key face image in Block B50 or in Block B51, the key image select module 231 outputs the data representing the key image and the key face images to the relevant image select module 233 (Block B52).

Thus, the key image select module 231 uses the calendar screen 42 and main-character selection screen 41, thereby to select the key image and key face image, in accordance with which still image data items 51 are extracted. The relevant image select module 233 selects, from the content database 301, still image data items 51 relevant to the key image and key face image based on the selected key image and key face image. Note that the key image may be selected not only from the moving picture or the calendar screen 42, but also from the list of the still image data items 51 stored in the content database 301.

FIG. 21 is an exemplary flowchart showing an example of sequence of the related image selecting process that the relevant image select module 233 executes.

First, the date/time relevant image select module 233A selects, from the content database 30, the still image data items 51 generated on the date when the key image was generated (Block B61). Next, the person relevant image select module 233B selects still image data items 51 including data representing the face images relevant to the key face image (Block B62). Then, the location relevant image select module 233C selects the still image data items 51 relevant to the location where the key image has been generated, from the still image data items 51 stored in the content database 301 (Block B63).

The still image data items 15 selected by the date/time relevant image select module 233A, person relevant image select module 233B and location relevant image select module 233C are output from the relevant image select module 233 to the scenario determination module 234 (Block B64).

Thus, the relevant image select module 233 selects the still image data items 51 relevant to the key image and key face image. The moving picture generation module 235 generating a moving picture (photomovie) or a slide show, by using the selected still image data items 51.

As has been described, this embodiment can apply more prominent effects to still images, by utilizing the attribute information about the face included in the index information 302A (i.e., smile degree, clearness, frontal degree, and personal ID).

The sequence of image displaying processes is achieved by software in the present embodiment. Hence, a computer of an ordinary type can easily achieve the same advantage as this embodiment, only if the program for performing this sequence is installed into the computer via a computer-readable storage media holding the program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a face image detector configured to detect face images in a still image, to analyze the detected face images, and to generate face image information comprising position information and attribute information, the position information indicating positions where the face images are detected, and the attribute information indicating at least data items representing smile degrees of the face images; and
a display controller configured to select a face image to be applied with effects based on the attribute information in the face image information, to apply effects to the still image based on the position information in the face image information of the selected face image, and to display the still image applied with the effects.

2. The apparatus of claim 1, wherein the display controller is configured to apply an effect to the still image for arranging an object around the selected face image.

3. The apparatus of claim 1, wherein the display controller is configured to apply an effect to the still image for displaying a circular area comprising the selected face image in one brightness and the other area of the still image in another brightness.

4. The apparatus of claim 1, wherein the display controller is configured to apply an effect to the still image for changing the still image displayed in a first state to a still image displayed in a second state, the still image displayed in the second state containing an enlarged selected face image.

5. The apparatus of claim 1, wherein the display controller is configured to select a number of face images in descending order of smile degree and to apply an effect to the still image for arranging objects around the selected face images, each object indicating the ranking of the smile degrees.

6. The apparatus of claim 1, wherein the face image detector is configured to calculate sharpness of each of the face images as the attribute information.

7. The apparatus of claim 1, wherein the display controller is configured to display a first still image followed by a second still image, the first still image containing the selected face image being displayed and the second still image not containing the selected face image.

8. The apparatus of claim 1, wherein:
the face image detector is configured to analyze the face images and classify the face images into groups corresponding to persons, and to generate classification information as the attribute information; and
the display controller is configured to sequentially display a plurality of still images, to select a face image to be applied with effects based on the classification information, and to apply effects to still images that contain the selected face image.

9. An image display method comprising:
detecting face images in a still image;
analyzing the detected face images;
generating face image information comprising position information and attribute information, the position information indicating positions where the face images are detected, and the attribute information indicating at least data items representing smile degrees of the face images;
selecting a face image to be applied with effects based on the attribute information in the face information;
applying effects to the still image based on the position information in the face image information of the selected face image; and
displaying the still image applied with the effects.

10. The method of claim 9, wherein applying effects comprises applying an effect to the still image for arranging an object around the selected face image.

11. The method of claim 9, wherein applying effects comprises applying an effect to the still image for displaying a circular area comprising the selected face image in one brightness and the other area of the still image in another brightness.

12. The method of claim 9, wherein applying effects comprises applying an effect to the still image for changing the still image displayed in a first state to a still image displayed in a second state, the still image displayed in the second state containing an enlarged selected face image.

13. The method of claim 9, wherein applying effects comprises
selecting a number of face images in descending order of smile degree and
applying an effect to the still image for arranging objects around the selected face images
respectively, each object indicating the ranking of the smile degrees.

14. The method of claim 9, wherein analyzing detected face images comprises calculating sharpness of each of the face images as attribute information.

15. The method of claim 9, wherein displaying the still image comprises sequentially displaying first still image followed by a second still image, the first still image containing the selected face image being displayed prior and the second still image not containing the selected face image.

16. The method of claim 9, wherein:
analyzing detected face images comprises
analyzing the face images and
classifying the face images into groups corresponding to persons, and
generating classification information as the attribute information; and
selecting the face image comprises selecting a face image to be applied with effects based on the classification information.
